(19) United States
(12) Patent Application Publication
(10) Pub. No.: US 2003/0119575 A1
(43) Pub. Date: Jun. 26, 2003

(54) Method and apparatus for playing a gaming machine with a secured audio channel

(76) Inventors: Charlotte S. Centuori, Henderson, NV (US); Leslie H. Sarile, Las Vegas, NV (US)

Correspondence Address: MARSHALL GERSTEIN & BORUN, 6300 SEARS TOWER, 233 SOUTH WACKER DRIVE, CHICAGO, IL, 60606-6402, US

(21) Appl. No.: 10/028,401

(22) Filed: Dec. 21, 2001

(51) Int. Cl. A63F 13/00

(52) U.S. Cl. 463/20; 463/35

(57) ABSTRACT

An apparatus, method and system for providing substantially isolated sound from a game unit to a user of the game unit. The game unit includes an audio output element that is configured to an audio headset. The game unit includes a central processing unit (CPU), at least one display element, an audio card in communication with the CPU, and an audio output element in communication with the audio output element. The CPU of the game unit is configured to effect play of a game, video signals of which are shown on the at least one display element and audio signals of which are communicated to the audio card and video output element. The audio output element is configured to provide substantially isolated and secure sound to a headset in communication with the audio output element and worn by a user of the game unit.

### BACKGROUND OF THE INVENTION

1. Field of the Invention

The present invention relates to apparatus and methods for conducting games of chance and, in particular, apparatus and methods for conducting games of chance with enhanced audio capabilities.

2. State of the Art

Game units and their methods and apparatus for use are well known in the art. Game units may include games of chance, games of skill, and games involving both skill and chance. Examples of patents describing various game units include U.S. Pat. No. 5,833,536 to Davids et al. (Nov. 10, 1998), U.S. Pat. No. 5,769,716 to Saffari et al. (Jun. 23, 1998), U.S. Pat. No. 5,820,460 to Fulton (Oct. 13, 1998) and U.S. Pat. No. 5,947,820 to Morro et al. (Sep. 7, 1999).

Electronic game units typically are coupled to a microprocessor or another computer having a central processing unit (CPU) and memory. The game unit conventionally includes a number of peripheral devices such a display screen having a touch screen input (see U.S. Pat. No. 5,951,397 to Dickinson (Sep. 14, 1999)) for display of graphics associated with one or more games playable on the game unit. Buttons, keys or other user input devices are also operatively coupled to the CPU for initiating game play and for other functions associated with play of the game unit. Typically, a coin, currency or card acceptor (to accept a credit card, gaming card, smart card and the like) permits a player to enable play of a game by placing one or more wagers. The electronic game may also include separate displays to indicate a player's success or display the player's accumulated winnings. A coin and/or currency dispenser may also be included to “cash-out” a player's winnings or remaining credits, or a player's winnings credited back to him or her using the card acceptor.

Electronic games may also be coupled to one or more other computers such as a central controller or central computer of a casino, e.g. via a network card and link, modem or the like. The game parameters, such as how, when and where particular images will appear on the display screen, how the game works and how to operate the various elements operatively coupled to the computer, are stored in the memory. Often, the electronic game may be housed in a structural and/or decorative housing. Such housing will typically include audio speakers for assisting the play of a game or to provide noise that corresponds to winning or noise corresponding to various aspects of a particular game.

In addition to the manner described above, it is also possible to participate in a game of chance via the Internet. This is typically accomplished through a casino or game host site offering displays similar to those found in conventional electronic games. Generally, to play a game of chance via the Internet, a software file is downloaded to a player's computer or terminal, which may then be used to install the necessary software for the game and/or access the casino or game host Internet site. However, such gaming may also be “streamed” across the Internet as with video and audio streaming techniques. As with a conventional electronic game, Internet electronic games may be accessed using an identification code or name to identify a specific player and retrieve that player's credit total or play history.

Gaming technology is also utilizing wireless Internet technology to facilitate participating in a game of chance or to wager on various events, such as video poker, video slot machines, horse races and the like. For example, U.S. Pat. No. 5,999,808 to LaDue discloses a compact personal computer, allowing a player to make wagers on such compact personal computers most anywhere so long as the location the player chooses to wager receives wireless Internet coverage. Such gaming technology will typically already include the required software to play the various games of chance and works similar to typical Internet technology gaming as discussed above.

With the advances in gaming technology, casino gaming machines have proliferated in recent years. As the number of casinos and gaming outlets has increased, the competition to attract and retain new customers has intensified. This competition for patrons requires the continual development of new games that are exciting and entertaining. To meet this need, many casino gaming machines have incorporated music, voice, and other sound effects into their gaming machines. These sound effects are used to attract patrons to play the game, and to make the game more fun and exciting during game play. With ever increasing emphasis, sound effects are also being employed as an interactive mechanism to prompt players as part of the game play. These interactive games are becoming increasingly more popular and dramatically increase the need for a patron to clearly hear the game to play it effectively.

As the number of machines with sound effects proliferates, casino noise levels have significantly increased. As the ambient noise level increases, the sound level of individual gaming machines has been increased to be heard and, as a result, ambient casino noise levels continue to escalate. Competition between game manufacturers has also manifested itself in gaming machines that produce longer and louder audio clips in an effort to attract players. As a result, players have long complained that they cannot hear the machines that they are playing and that the ambient casino noise is too high to provide a pleasant gaming experience.

Casino noise levels are becoming even more problematic because of the recent trend towards sophisticated interactive gaming machines, which generally require the delivery of clear audio messages for successful game play. Such interactive games may require a player to respond to audio prompts. In other cases, these machines provide audio instructions that a player needs to hear to effectively participate in the game. The inability to understand or hear the messages makes it difficult for these types of games to be successful in casinos. Without significant noise suppression, use of an entire class of games may be precluded.

One example of a gaming machine providing audio capabilities is disclosed in U.S. Pat. No. 5,259,613 to Marnell. The Marnell patent is a casino gaming machine with a video monitor and a microphone/speaker combination. The microphone/speaker combination is used to communicate with an operator at a central control station. The speaker of such combination is installed in the cabinet to openly provide noise to the casino environment. As such, the speakers only reinforce the problems with the current standard casino gaming machines by increasing the ambient noise level in the casino.

U.S. Pat. No. 5,971,271 to Wynn discloses a communication link with concierge services during play of a gaming machine, such as hand pay jackpots, coin refills, etc. Such a communication link is employed with a speaker and microphone at the gaming machine. U.S. Pat. No. 6,139,431 to Walker et al. discloses a gaming machine that provides free long distance telephone calls or audio entertainment as a reward for the continued playing of the gaming machine. Such audio entertainment includes audio for comedy, music, news and the like.

Based on the foregoing, it would be advantageous to provide a method, apparatus and system that allows players to clearly hear the audio output element emanating from the casino gaming machine that they are playing.

### BRIEF SUMMARY OF THE INVENTION

The present invention relates to apparatus, methods and systems for providing substantially isolated sound from a game unit to an individual player. The present invention is directed to an audio output element in a game unit operatively coupled to an audio headset. The game unit includes at least one game unit having at least one display thereon. The at least one game unit is configured to effect play of a game, such as a game of chance, in which a central processing unit of the game unit generates a random outcome comprised of a plurality of random outcomes and the at least one display is configured to display at least the random outcome. Each game unit includes an audio card and an audio output element attached thereto. According to the present invention, the audio output element is configured to provide substantially isolated sound to the individual player via the operatively coupled audio headset.

In an exemplary embodiment, the audio output element includes at least an audio port configured to interconnect with a connection port of the audio headset. The audio headset may include at least an audio ear device with an audio wire extending therefrom and the connection port at an end of the audio wire. With this arrangement, an individual player may removably engage the connection port of the audio headset with the audio port in the audio output element. The individual player positions the audio ear device adjacent one or both of his or her ears such that the audio ear device may then transmit the sound of the game unit to the individual player in a substantially isolated and secure manner.

The audio output element may also include one or more speakers. Such speakers are configured to provide game play audio, which contributes to the ambient noise in the casino. According to one aspect of the present invention, the audio output element may provide game play audio through the audio headset and through the one or more speakers. In this manner, the speakers provide game play audio to attract bystanding potential players while the audio headset provides isolated sound to the individual player. Such isolated sound provides a means for the player to clearly hear the game the player is playing.

In another aspect of the present invention, the sound card is interconnected to a multi-channel mixer circuit. Such a mixer circuit provides the option to choose multiple channels which may be listened to sequentially or simultaneously through the audio headset. The channels to choose from may include at least one of game play audio, music channels, promotional channels, and informational channels. Thus, it is through the isolated and secure sound of the audio headset that an individual player may listen to multiple channels during the course of game play.

In a variant of this exemplary embodiment, the audio output element includes at least a transmitter member configured to transmit or broadcast the sound to a wireless audio headset. The wireless audio headset utilized in this variant includes at least an audio ear device interconnected with a receiver member and an antenna. The wireless audio headset may be adjusted to correspond with the transmitting channel that the transmitter member is broadcasting at so that an individual player may receive the broadcasted audio transmission through the audio ear device of the wireless audio headset in a substantially isolated and secure manner. Such wireless audio headset of the present invention may be utilized with multiple channels facilitated by the mixer circuit and/or the one or more speakers in providing isolated sound to the individual game player.

In a second embodiment, the game unit of the present invention comprises a portable game unit. Such portable game unit also includes an audio output element that includes one or more of an audio port, one or more speakers, and a transmitter. The portable game unit of the second embodiment provides that the audio headset with a wire hookup or the wireless audio headset may be utilized therewith. Such portable game unit may be utilized with the audio headset most anywhere so long as the portable game unit can communicate wirelessly with a game server.

Another aspect of the present invention includes a gaming system. Such a gaming system may include a plurality of game units, with each game unit comprising a game terminal or other device at which a game of chance may be played. Each game unit includes, among other things, a sound card and an audio output element in communication therewith. Each game unit may communicate with a central controller. By way of example only, the game units may be conventional game units that communicate with a central controller.

Other features and advantages of the present invention will become apparent to those of skill in the art through a consideration of the ensuing description, the accompanying and the appended claims.

### BRIEF DESCRIPTION OF THE SEVERAL VIEWS OF THE DRAWINGS

While the specification concludes with claims particularly pointing out and distinctly claiming that which is regarded as the present invention, the advantages of this invention may be ascertained from the following description of the invention when read in conjunction with the accompanying drawings, wherein:

FIG. 1 is a schematic of an electronic game unit including an audio output element according to the present invention;

FIG. 2 is a simplified frontal view of an electronic game unit including an audio output element according to the present invention;

FIG. 3 is a simplified perspective view of an audio headset for using with an electronic game unit according to the present invention;

FIG. 4 is a simplified block diagram of the sound card 140 and multi-channel mixer circuit 142 in the game unit of the present invention;

FIG. 5 is a simplified perspective view of a wireless audio headset for using with an electronic game unit according to the present invention; and

FIG. 6 is a simplified frontal view of a portable electronic game unit having an audio output element according to the present invention.

### DETAILED DESCRIPTION OF THE INVENTION

Embodiments of the present invention will be hereinafter described with reference to the accompanying drawings. It would be understood that these illustrations are not to be taken as actual views of any specific apparatus or method of the present invention, but are merely exemplary representations employed to more clearly and fully depict the present invention than might otherwise be possible. Additionally, elements and features common between the drawing figures retain the same numerical designation.

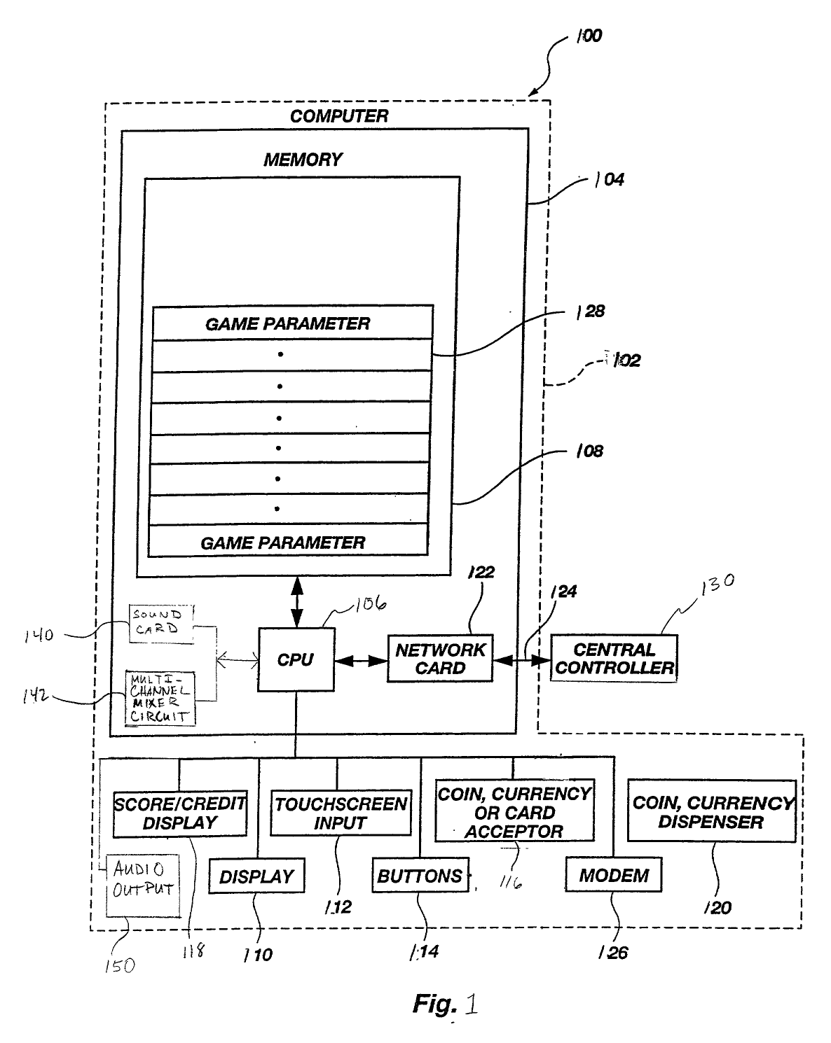

Referring to FIG. 1, an exemplary game unit 100 used in conjunction with the present invention is illustrated. Such game unit 100 may be any type of device known in the art for use in wagering on and playing games of chance, which game unit may also be referred to herein as a game unit, gaming terminal, electronic game, gambling unit, or combinations thereof.

The game unit 100 may comprise a computer 104 with a central processing unit (CPU) 106 and memory 108 which may serve, in part, as a random number generator. The computer 104 may be coupled to a number of peripheral devices such as, by example only, one or more display elements 110 (e.g., a cathode ray tube (CRT), plasma display, liquid crystal display (LCD), light emitting diode (LED) display, etc., or some combination thereof) for display of graphics associated with one or more games stored in memory 108 and executable by CPU 106 for play on game unit 100. Buttons, keys, touch sensitive regions 112 of a display element 110, and/or other user input devices 114 may also communicate with CPU 106 for initiating and effecting game play and for other functions associated with play of a game.

A credit input device 116 of a known type, such as a coin, currency or card acceptor device (to accept a credit card, gaming card, smart card, or the like) is on game unit 100 so that a player may insert coin, currency or a card therein to obtain credits on the game unit 100 so that game play may be initiated by the player placing one or more wagers. The electronic game may also include a separate scoreboard display 118 to indicate a player's success, such as displaying the player's accumulated winnings or losses. A credit dispenser 120, such as a coin or currency dispenser of a known type or the aforementioned card reader, may also be included on game unit 100.

The game unit 100 may also be coupled to one or more other computers, such as a central controller 130 of a casino, for example, via a network card 122 and a link 124 coupled thereto, a modem 126, or the like, for configuration and monitoring of the game unit 100 by the central controller 130 or by a casino employee using the central controller 130. Alternatively, multiple game units 100 may communicate with one another through the central controller 130 or directly by communication elements, such as network card 122 and link 124 or modem 126 for tournament style gaming.

The game parameters 128, such as how, when and where particular images will appear on the display screen 110, how the game works and how to operate the various elements operatively coupled to the computer 104, may be stored in the memory 108, which may comprise a hard disc, random access memory (RAM), read-only memory (ROM), firmware, or programmed or programmable hardware. The game unit 100 may be housed in a structural and/or decorative housing 102 (shown in broken lines), as is well known and understood by those of ordinary skill in the art.

According to the present invention, the game unit 100 includes a sound card 140 in communication with the CPU 106 of the game unit 100. The sound card 140 is configured to provide audio signals generated by CPU 106 to an audio output element 150. The audio output element 150 is configured to provide an audio link from the game unit 100 directly to the player. Such an audio output element 150 provides substantially secure and/or isolated audio signals to the player so that player can effectively hear and play the game unit without the obstruction of looming ambient noise. The audio signals additionally provide a substantially secure link to the player so that confidential information or information particular to the player's game play may be successfully passed to the player. In some instances, such substantially secure and/or isolated audio signals transmitted to the player may be advantageous to allow a player to enjoy game play most anywhere without such audio signals being overheard by others proximate to the player.

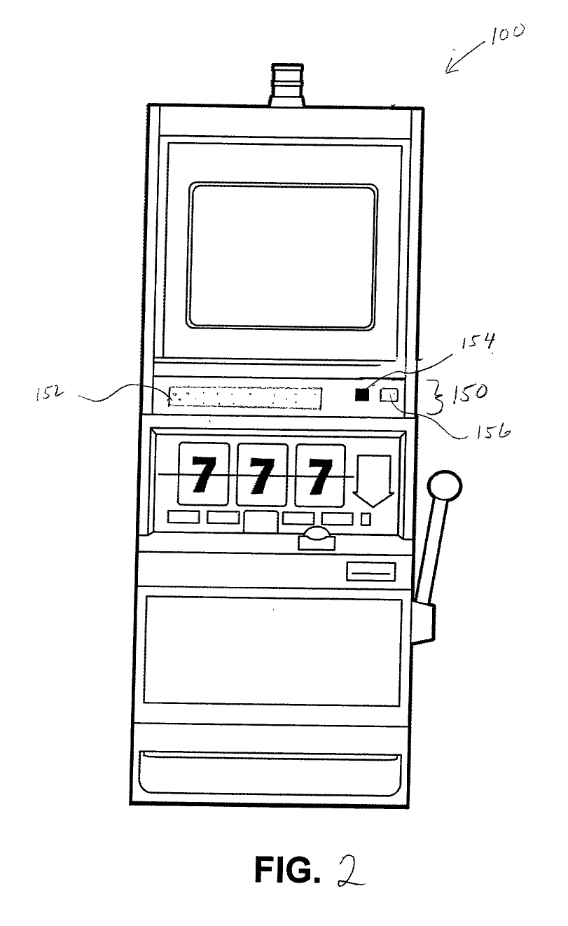

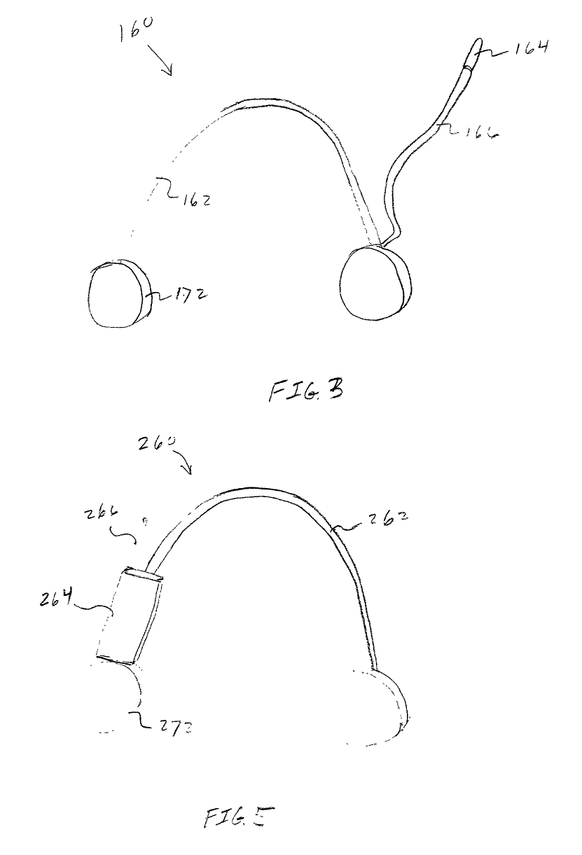

FIG. 2 illustrates one example of a game unit 100, such as a typical slot machine, including audio output element 150. As shown, the audio output element 150 may include one or more speakers 152, an audio port 154 and a transmitter 156. The audio port 154 is preferably a female audio port made to receive a male port 164 (see, FIG. 3), such as a female audio jack or banana port. The transmitter 156 may be provided with the audio output element 150 for broadcasting by wireless transmission described in further detail below.

FIG. 3 illustrates an audio headset 160 for use with game unit 100. The audio headset 160 may be any typical audio headset as known in the art. Such audio headset 160 typically may include a head band 162 with two ear pieces 172 that comprise audio speakers at each end thereof and an audio wire 166 extending from the audio headset 160. The head band 162 preferably is configured to adjustably extend around an upper periphery of a player's head so that the ear pieces 172 sit proximate the player's ears. However, the audio headset 160 may be any known audio sound device that provides substantially isolated and/or secure audio signals to one or both ears of a player, such as a single ear piece, without the head band, with the audio wire 166 or the like extending from the single ear piece. The audio wire 166 extending from the headset 160 includes a connection port 164 at an end thereof, such as a male audio jack or banana port.

Referring to FIGS. 2 and 3, a first embodiment of the present invention utilizes the audio output element 150 in conjunction with the audio headset 160. Specifically, the connection port 164 at the end of the audio wire 166 of the audio headset 160 is configured to removably engage and interconnect with the audio port 154 in the audio output element 150 of the game unit 100. In this manner, a player may removably engage or insert the connection port 164 in the audio port 154 so that the player may position the audio headset 160 to his or her ears to thereby allow the player to more clearly hear and, thereby, play the game unit 100 without the obstruction of looming ambient noise. The audio headset 160 receives audio signals from the audio output element 150, allowing the player to receive substantially secured and/or isolated audio for game play.

Each game unit 100 or portable game unit 300 may be supplied with the audio headset 160. Alternatively, a player may be provided with their own audio headset 160 to play any of the game units 100 in a casino configured with the audio output element 150 and the sound card 140.

Such an audio headset 160 not only provides secured and/or isolated audio signals to the player; it also helps prevent a player from hearing the ambient casino noise. The volume of the audio signals may be increased or decreased as desired by the player via a volume control on either the audio headset 160 or a volume control at the audio output element 150 on the game unit 100. Such adjustability is particularly helpful to those players that may have difficulty hearing. As such, a player may be immersed in game play without being distracted by the ambient noise of the casino, thereby, allowing the extensive audio effects and the information of any particular game unit to be more fully appreciated and utilized by a player.

Furthermore, the audio capabilities of the present invention prevents players from becoming confused due to the complex nature of some of the games. As such, audible explanations may be provided by a game unit 100 as to how to play the game, with additional audio prompts being given during game play to assist the player in understanding the events as they unfold, as well as various choices that may be available to the player. The enhanced audio capabilities increases player participation in new games that may be hard to understand to some players and also helps speed game play by prompting the player to make decisions in regards to and during game play at a quicker pace. In addition, such audio capabilities may increase the marketability and entertainment value of the game and reduce player frustration.

In addition to the above noted audio capabilities, it may be desirable to have a secure line of communication that cannot be easily compromised between the casino or a central controller thereof and players. For example, it is often desirable to communicate gaming or casino information confidentially to a specific player. This information may include amounts won, or available credits, or other monetary information relative to the player's success on the game unit. This information may also include special awards or other complimentary prizes awarded to players based on player tracking cards or game play that the casino (or the player) may not want communicated to or seen by others.

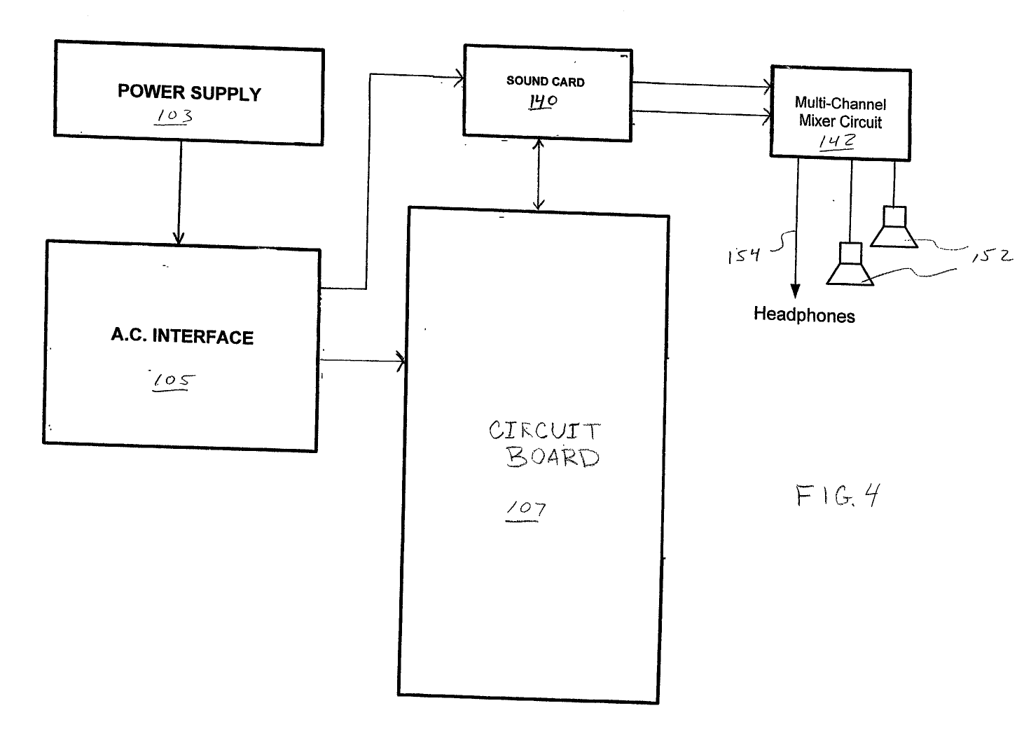

In one aspect of the present invention, the game unit 100 may include a multi-channel mixer circuit 142 in communication with the sound card 140. Referring to FIG. 4, a block diagram of the sound card 140 and multi-channel mixer circuit 142 is illustrated. The block diagram also illustrates a power supply 103 for powering the game unit. Power from the power supply is converted from an alternating current (AC) to a direct current through an AC interface 105. The AC interface 105 is coupled to the sound card 105 and a circuit board 107 to communicate power to the CPU 106, memory 108, network card 122, etc., associated with the circuit board 107. The sound card 140 may in turn be coupled to the multi-channel mixer circuit 142, which provides multiple audio lines to speakers 152, audio port 154, etc.

Such multi-channel mixer circuit 142 may provide an option for a player to choose from multiple audio channels in addition to the audio signals of the particular game being played. The multiple audio channels to choose from may include various music channels, news channels, sports channels, general informational channels, promotional channels, confidential information, etc. Such a mixer circuit 142 may cause the audio output element associated with game play to be mixed with audio signals from a channel that has been selected by the player. As known in the art, the sound card 140 may be controlled by CPU 106, as directed by an appropriate program to allow the audio signals for the particular game to be mixed with or overlaid with another audio channel. In this manner, a player may listen to both the audio for game play and audio for one or more other types of audio channels that may, or may not, be associated with the play of the particular game.

In a further aspect of the present invention, in addition to audio capabilities through a head set 160, as discussed above, the audio signals may also be conveyed through speakers 152 of the game unit 100. Such speakers 152 may provide audio signals simultaneous to the audio signals provided through the audio headset 160. These may be the same audio signals, different audio signals, or some combination thereof. Of course, the CPU 106, the sound card 140 and/or a multi-channel mixer circuit 142 may select the appropriate destination or destinations for each audio signal. The audio port 154 and audio headset 160 need not entirely supplant the speakers 152. Instead, the speakers 152 may still be used to promote the game unit 100, to attract game interest of bystanding potential players previous to or as the game is being played, and to add to the overall ambience of the casino gaming floor by providing an audio output element at an appropriate sound level. Simultaneously, the player has an undistorted audio feed directly from the game unit via the audio port 154 and audio headset 160. As such, there may be multiple distinct and separate audio lines, wherein one audio feed may extend to the audio headset 160 and another audio feed may extend to the speakers 152 of game unit 100.

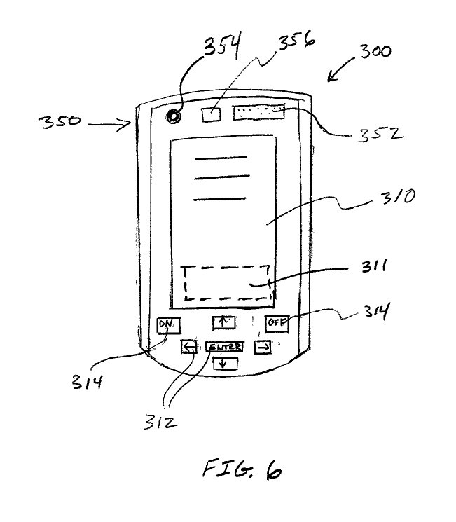

FIG. 5 illustrates a wireless audio headset 260 for use with game unit 100. The wireless audio headset 260 is similar to the previously discussed audio headset, except the wireless audio headset 260 does not include an interconnecting wire to transmit audio signals therethrough. Rather, the audio headset 260 may include a receiver member 264 and an antenna 266 in addition to a head band 262 and ear pieces 272.

Referring to FIGS. 2 and 5, a variant of the first embodiment of the present invention utilizes the audio output element 150 in conjunction with the wireless audio head set 260. In particular, the audio output element 150 may include a transmitter member 156 for transmitting or broadcasting the game play of its respective game to the receiver member 264 on the wireless audio headset 260. As such, the audio output element 150 may provide audio capabilities for both an audio headset 160 having an interconnecting wire and a wireless audio headset 260. Alternatively, a transmitter member 156 may be coupled to the audio output element 150 of a game unit 100. The transmitting member 156 and receiver member 264 may both operate over a variety of mutually cooperative frequencies or channels or a manually or automatically programmed frequency or channel that is unique to a particular game unit 100. The wireless audio headset 260 may be advantageous over the audio headset 160 requiring an interconnecting wire in that the wireless audio headset 260 substantially frees the player from the clumsiness and restraint of headphones interconnected by a wire to the game unit 100.

FIG. 6 illustrates a portable game unit 300 having an audio output element 350 as another exemplary embodiment of the present invention. The portable game unit 300 may be a personal data assistant (“PDA”) or similar apparatus configured to communicate by way of a known wireless connection protocol with a central controller 130 (FIG. 1). Such a portable game unit 300 may include a display 310, such as a liquid crystal display, directional/enter buttons 312 and on/off power buttons 314, a transmitter/receiver member 360, and an audio output element 350. The directional/enter buttons 312 may be used to select and implement menu-driven game play for wagering on the portable game unit 300. The transmitter/receiver member 360 may be configured to wirelessly receive information, including game information, account information, etc., and wirelessly transmit information such as game responses, wager information, credit card information, etc., via the directional/enter buttons 312 or a touch-sensitive region 311 of the display 310. Such a transmitter/receiver member 360 receives information from and transmits information to a remote central controller 130 (FIG. 1). A processor of the portable game unit 300 may be updated with any received information. Such updates may be shown to the player on the display 310, as known in the art. The portable game unit 300 may operate as known in the art, such as with gaming software and/or circuitry configured for game play on the portable game unit 300.

The audio output element 350 of the portable game unit 300 may include an audio port 354, such as a female member of an audio jack or a banana port. In addition to the audio output element 350, the portable game unit 300 may include one or more speakers 352. The audio output element 350 is similar to the first embodiment in that the speakers 352 may provide sound to the player at a volume for the player to hear and any other person nearby to hear, while other audio signals may be heard only by a player wearing an audio headset 160, 260 (FIGS. 3 and 5).

The portable game unit 300 provides the versatility of essentially being able to gamble anywhere a wireless communication with a central controller 130 (FIG. 1) is possible with the audio capabilities of the present invention. Thus, a player is able to wager on a game of chance most anywhere in a discreet manner while also enjoying substantially clear, isolated and secured sound to the player through the audio output element 350 of the portable game unit 300.

While the present invention has been disclosed in terms of certain preferred embodiments and alternatives thereof, those of ordinary skill in the art will recognize and appreciate that the invention is not so limited. Additions, deletions and modifications to the disclosed embodiments may be effected without departing from the scope of the invention as claimed herein. Similarly, features from one embodiment may be combined with those of another while remaining within the scope of the invention.

What is claimed is:

1. A game unit comprising:
at least one central processing unit configured to effect play of a game;
at least one display in communication with said at least one central processing unit;
at least one audio card in communication with said at least one game unit; and
an audio output element in communication with said at least one audio card, said audio output element configured to provide a user of the game unit with sound substantially isolated from ambient sound of an environment in which the game unit is located.

2. The game unit of claim 1, further comprising an audio headset configured to operatively interconnect with said audio output element and provide said substantially isolated sound.

3. The game unit of claim 2, wherein said audio output element comprises a member of an audio jack.

4. The game unit of claim 3, wherein said audio headset includes another member of said audio jack configured to removably interconnect with said member of said audio jack of said audio output element.

5. The game unit of claim 4, wherein said another member of said audio jack communicates with at least one ear piece of said audio headset by way of an audio wire coupled therebetween.

6. The game unit of claim 1, wherein said audio output element includes a volume adjustment control.

7. The game unit of claim 1, further comprising an audio headset configured to communicate wirelessly with said audio output element.

8. The game unit of claim 7, wherein said audio output element comprises a transmitter member configured to transmit audio signals.

9. The game unit of claim 8, wherein said audio headset comprises a receiver member configured to receive said audio signals transmitted by said transmitter member.

10. The game unit of claim 9, wherein said transmitter member and said receiver member are configured to operate on at least one common frequency.

11. The game unit of claim 1, further comprising a multi-channel mixer circuit in communication with said audio card.

12. The game unit of claim 11, wherein said multi-channel mixer circuit facilitates selection of at least one audio channel by a user of the game unit.

13. The game unit of claim 12, wherein said multiple-channel mixer circuit is configured to transmit audio signals of at least two selected audio channels to said audio output element.

14. The game unit of claim 1, wherein said audio output element is configured to provide a user of the game unit with information with respect to game play on the game unit.

15. The game unit of claim 1, further comprising at least one audio speaker in communication with said at least one audio card.

16. The game unit of claim 15, wherein audio signals are transmitted to said audio output element and said at least one speaker.

17. The game unit of claim 16, wherein said distinct audio signals are transmitted to output element and said at least one speaker.

18. The game unit of claim 1, comprising a portable game unit.

19. The game unit of claim 18, wherein said portable game unit is configured to wirelessly communicate with a central controller.

20. A method of conducting a game of chance on a game unit, comprising:
providing a user of the game unit with an audio headset; and
transmitting at least one audio signal from the game unit to said audio headset during play of at least one game of chance on the game unit.

21. The method of claim 20, further comprising connecting said audio headset to the game unit with at least one wire.

22. The method of claim 21, wherein said transmitting is effected along said at least one wire.

23. The method of claim 20, wherein said providing comprises providing an audio headset comprising a receiver member.

24. The method of claim 23, wherein said transmitting comprises wirelessly transmitting said at least one audio signal from the game unit.

25. The method of claim 23, further comprising receiving said at least one audio signal with said receiver member.

26. A gaming system comprising:
a central controller;
a plurality of game units in communication with said central controller, each game unit of said plurality of game units configured to effect play of a game and comprising:
at least one central processing unit;
at least one display, said at least one display in communication with said at least one central processing unit and configured to display at least a portion of said game;
an audio card in communication with said central processing unit; and
an audio output element in communication with said audio card, said audio output element configured to provide a user of the game unit with sound substantially isolated from ambient sound in an environment in which the game unit is located.

27. The gaming system of claim 26, further comprising an audio headset that communicates with said audio output element of each said game unit for substantially isolating said sound from said ambient sound.

28. The gaming system of claim 27, wherein said audio headset and said audio output element are configured for removably engaging one another.

29. The gaming system of claim 28, wherein a wire of said audio headset is configured to be coupled between at least one ear piece of said audio headset and said audio output element.

30. The gaming system of claim 26, further comprising:
a volume adjustment control for said individual player associated with said audio output element.

31. The gaming system of claim 27, wherein said audio headset is configured to wirelessly communicate with said audio output element.

32. The gaming system of claim 31, wherein said audio output element comprises a transmitter member for wirelessly transmitting audio signals.

33. The gaming system of claim 32, wherein said audio headset comprises a receiver member configured to receive said audio signals from said transmitter member.

34. The gaming system of claim 26, wherein said game unit comprises a multi-channel mixer circuit in communication with said audio card.

35. The gaming system of claim 34, wherein said multi-channel mixture is configured to facilitate selection of at least one audio channel comprising at least one of game play audio of said at least one game unit, multiple music channels, informational channels, promotional channels, sports channels, and news channels in addition to game play audio of said at least one game unit.

36. The gaming system of claim 34, wherein said multiple-channel mixer circuit is configured to provide at least two audio channels for a user of said game unit to listen to during game play.

37. The gaming system of claim 36, wherein said central processing unit of said game unit is configured to provide options to the user of audio channels that may be listened to along with game play audio.

38. The gaming system of claim 26, wherein said game unit further comprises at least one audio speaker in communication with said audio card.

39. The gaming system of claim 38, wherein said audio output element and said at least one speaker receive distinct audio feeds.

40. The gaming system of claim 38, wherein said audio output element and said at least one speaker are configured to simultaneously output audio signals.

41. The gaming system of claim 26, wherein at least one of said plurality of game units wirelessly communicate with said central controller.

42. The gaming system of claim 41, wherein said at least one game unit of said plurality of game units comprises a portable game unit.
